(19) United States
(12) Patent Application Publication
(10) Pub. No.: US 2004/0038587 A1
(43) Pub. Date: Feb. 26, 2004

(54) High frequency coaxial connector for microcircuit packaging

(76) Inventors: Hubert K. Yeung, Santa Rosa, CA (US); Michael T. Powers, Santa Rosa, CA (US); Wesley C. Whiteley, Santa Rosa, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/226,586

(22) Filed: Aug. 23, 2002

(51) Int. Cl. H01R 9/05

(52) U.S. Cl. 439/581

(57) ABSTRACT

A coaxial connector interfaces a launch end of the connector with a planar circuit mounted in a microcircuit package. The microcircuit package receives the connector through a borehole in a wall of the package. In some embodiments, the connector is axially adjustable and comprises a feed thru portion that is at least as long as the package wall is thick and has a smooth outer surface, such that the feed thru portion readily slides in the wall borehole. The connector is either a one-piece or a two-piece connector. In some of these embodiments, the connector further comprises an integrated launch substrate. In other embodiments, the coaxial connector comprises an integrated launch substrate with circuitry. The circuitry facilitates conversion of a coaxial propagation wave from the connector to a planar propagation wave at the planar circuit. In some of these other embodiments, the coaxial connector also is axially adjustable.

### TECHNICAL FIELD

The invention relates to RF, microwave and millimeter wave devices. In particular, the invention relates to coaxial connectors used at RF, microwave and millimeter wave frequencies.

### BACKGROUND ART

High frequency devices, circuits and subsystems, such as those operating at radio frequency (RF), microwave and millimeter wave frequency ranges, are often manufactured as a planar circuit and packaged in a microcircuit package. The package supports and protects the planar circuit as well as facilitating a connection to and integration of the planar circuit with one or more other circuits within a larger system. Additionally, the microcircuit package may also function as an electromagnetic shield effectively isolating the planar circuit from an environment outside the package. Shielding by the package typically necessitates the use of a ‘feed thru’ or connector to carry signals into and out of the package. A conventional approach to realizing such a connector for transmission of high frequency devices, circuits and subsystems is a coaxial ‘feed thru’ connector. In most cases, the coaxial connector not only provides a means for carrying electromagnetic waves through the package wall but also provides a convenient means for transitioning the planar circuit transmission line within the package to a coaxial transmission line, such as a semirigid coaxial cable used in the larger system.

FIG. 1A illustrates a conventional coaxial connector 30 used with a microcircuit package 10 in an exploded, cross-sectional view. The connector 30 is illustrative of a first class of coaxial connectors, the so-called ‘two-piece’ connector, and comprises a coaxial feed thru 32 that is fixed in a wall 12 of the microcircuit package 10. The feed thru 32 is typically mounted in a counter-bored borehole 16 in the package wall 12. The connector 30 further comprises a connector assembly 34 that either removably or non-removably connects to the feed thru 32 adjacent to an outside surface 15 of the package wall 12. A center pin 36 of the feed thru 32 connects at a first pin end 37a to a planar circuit 14 mounted in the package 10. At a second pin end 37b, the center pin 36 of the feed thru 32 connects to a center pin 38 at a first connector end 39a of the connector assembly 34. The connector assembly 34 facilitates signal connectivity between the planar circuit 14 and the larger system (not shown), thereby enabling the planar circuit 14 to receive signals from and/or send signals to the system. Typically, the connector assembly 34 is configured or adapted at a second connector end 39b to connect to either a standard or a non-standard mating connector (not shown) used with a coaxial transmission line, such as a semirigid coaxial cable.

FIG. 1B illustrates in a cross-sectional view another conventional coaxial connector 40 used with microcircuit packages. The coaxial connector 40 illustrated in FIG. 1B is often referred to as a ‘spark plug’ connector 40 owing to a resemblance between the connector and a spark plug used in an internal combustion engine. The spark plug-type connector 40 is representative of a second class of coaxial connectors in wide use with RF microcircuit packages. Conventionally, the connector 40 is mounted in a borehole 16′ in the package wall 12. The borehole 16′ has a threaded counter-bored portion 17 for receiving the connector 40. The connector 40 typically screws into the threaded counter-bore portion 17 of the borehole 16′ until a first connector end 42 of the connector 40 engages an end or a stop 19 of the counter-bored borehole 16′. The connector 40 has a center pin 44 that extends from the first connector end 42. Once secured in the wall 12 of the package 10, the center pin 44 of the connector 40 is connected to the planar circuit 14.

Among the difficulties often encountered with conventional coaxial connectors, such as the connector 30 and the spark plug-type connector 40, is that conventional connectors 30, 40 cannot be adjusted axially during installation in the package 10. In particular, conventional connectors 30, 40 typically must be ‘seated’ against a stop of one sort or another, as exemplified by the counter-bored boreholes 16, 16′ described with respect to the connectors 30, 40 illustrated in FIGS. 1A and 1B. As such, conventional connectors are unable to account for manufacturing irregularities, such as ‘tolerance build-up’ of the planar circuit 14 and/or microcircuit package 10.

As used herein, ‘tolerance build-up’ refers to an inability to adequately or precisely control a tolerance of a size of the planar circuit 14 and/or a size of the package 10 as well as a tolerance associated with a placement of the circuit 14 within the package 10 during manufacturing and assembly. Tolerance build-up leads to a physical uncertainty of an actual location of a connection pad or point on the planar circuit 14 with respect to an actual location of the installed connector 30, 40. In particular, tolerance control and tolerance build-up may become a critical problem as the physical location uncertainty becomes a large percentage of a wavelength at high operating frequencies. As a result, tolerance build-up usually must be tightly controlled during manufacturing/assembly to prevent mechanical and electrical problems from occurring at an interface between the connector 30, 40 and the planar circuit 14, especially for high frequency circuits and systems.

Accordingly, it would be advantageous to have a connector for device packaging that could be adjusted to accommodate tolerance build-up between device components installed in a package. Moreover, it would be advantageous if the connector could provide a hermetic seal at the connector-to-package interface and facilitate use of automated assembly equipment for device components installation in the package. Such a coaxial connector would address a longstanding need in the area of connectors for RF, microwave and millimeter wave device packaging.

### SUMMARY OF THE INVENTION

The present invention provides a coaxial connection for a microcircuit package used in packaging an RF, microwave, or millimeter wave circuit or device. The present invention may be axially adjustable. Furthermore, the present invention may provide for an integrated launch substrate and/or a hermetically sealed signal interface for the microcircuit package.

In an aspect of the present invention, an axially adjustable coaxial connector is provided. In some embodiments, the axially adjustable coaxial connector is a one-piece connector. The one-piece coaxial connector comprises a shell, a center pin, and a pin support. The pin support supports the center pin in a cylindrical borehole in the shell. The shell borehole extends along a center axis of the shell and forms a coaxial dielectric transmission line. The shell comprises a feed thru portion. The feed thru portion of the shell has a cylindrical outer surface that may be axially adjusted within a borehole through a package wall of the microcircuit package during connector installation. Axial adjustment of the one-piece connector according to the present invention enables a connection end of the center pin extending into a launch portion of the connector to be positioned for connection with respect to features of a planar circuit installed in the microcircuit package. In other embodiments, the axially adjustable coaxial connector is a two-piece connector. The two-piece connector comprises a feed thru sleeve and a connector assembly. The feed thru sleeve comprises a sleeve shell, a pin support, and a center pin. An outer surface of the sleeve shell is a smooth cylinder that may be axially adjusted during installation in a package to position the center pin in an optimal manner for connection with respect to features of the planar circuit installed in the microcircuit package. The connector assembly connects to the center pin preferably by screwing the connector into a threaded portion of the sleeve.

In another aspect of the invention, a coaxial connector having an integrated launch substrate is provided. The coaxial connector having an integrated launch substrate may be either a one-piece or a two-piece coaxial connector according to the present invention. The integrated launch substrate is mounted to an extended ground interface. The integrated launch substrate provides an electromagnetic transition from a coaxial transmission line within the connector to a planar transmission line that is compatible with the planar circuit. In addition, the integrated launch substrate facilitates the use of conventional inter-substrate interface connection methods and equipment for electrically connecting the connector to the planar circuit. Moreover, by integrating the launch substrate with the connector, a launch transition may be tested and optimized before it is installed into the package. In yet another aspect of the invention, a method of installing a coaxial connector and axially adjusting the connector during installation in a microcircuit package is provided.

Advantageously, a coaxial connector according to the present invention may be adjusted axially during installation into the microcircuit package enabling an attachment end of a center pin of the connector to be more precisely and optimally positioned with respect to features of a planar circuit or device within the package than with conventional connectors. Moreover, the integrated launch substrate fosters optimization of a transition for signal propagation of an electromagnetic wave from a mode propagating within the coaxial connector to a mode propagating on a planar transmission line of the circuit thereby providing for an optimized impedance match at a connector-to-circuit interface. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1A illustrates an exploded, cross-sectional view of a conventional RF coaxial connector and a package wall of a microcircuit package into which the connector may be installed.

FIG. 1B illustrates a cross-sectional view of another conventional RF coaxial connector installed in a package wall of a microcircuit package.

FIG. 2A illustrates a perspective view of an embodiment of a one-piece axially adjustable coaxial connector according to the present invention.

FIG. 2B illustrates an exploded perspective view of the one-piece axially adjustable coaxial connector embodiment illustrated in FIG. 2A.

FIG. 2C illustrates a cross-sectional view of the one-piece axially adjustable coaxial connector embodiment illustrated in FIG. 2A installed in a package wall of a microcircuit package.

FIG. 3A illustrates a perspective view of an embodiment of a launch portion of the connector illustrated in FIG. 2A adapted for connection to a planar circuit having a microstrip transmission line.

FIG. 3B illustrates a perspective view of an embodiment of a launch portion of the connector illustrated in FIG. 2A adapted for connection to a planar circuit having a coplanar transmission line.

FIG. 4A illustrates a partially exploded, perspective view of an embodiment of a two-piece axially adjustable coaxial connector according to the present invention.

FIG. 4B illustrates a cross-sectional view of an embodiment of a feed thru sleeve and an embodiment of a connector assembly of the two-piece axially adjustable coaxial connector illustrated in FIG. 4A.

FIG. 4C illustrates a cross-sectional view of the two-piece axially adjustable coaxial connector embodiment illustrated in FIG. 4A installed in a package wall of a microcircuit package.

FIG. 5A illustrates a perspective view of an embodiment of a portion of a coaxial connector with an integrated microstrip launch substrate according to the present invention.

FIG. 5B illustrates a perspective view of an embodiment of a portion of a coaxial connector with an integrated coplanar waveguide launch substrate according to the present invention.

FIG. 5C illustrates a perspective view of an embodiment of a portion of a coaxial connector with an integrated coplanar waveguide launch substrate connected to and supported by a frontside shelf according to the present invention.

FIG. 5D illustrates a cross-sectional view of an embodiment of an axially adjustable coaxial connector with an integrated microstrip launch substrate installed in a package wall of a microcircuit package according to the present invention.

FIG. 6 illustrates a flow chart of an embodiment of a method of installing a coaxial connector and axially adjusting the connector during installation in a microcircuit package according to the present invention.

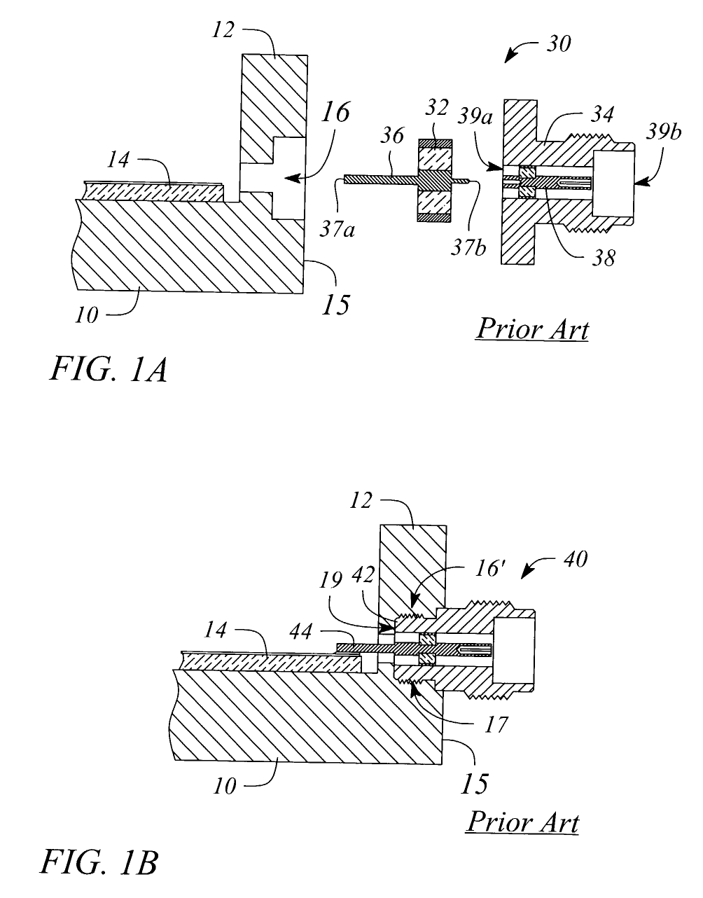

### MODES FOR CARRYING OUT THE INVENTION

In one aspect of the present invention, an axially adjustable coaxial connector is provided. In some embodiments, the axially adjustable coaxial connector is a one-piece connector while in other embodiments the axially adjustable coaxial connector is a two-piece connector.

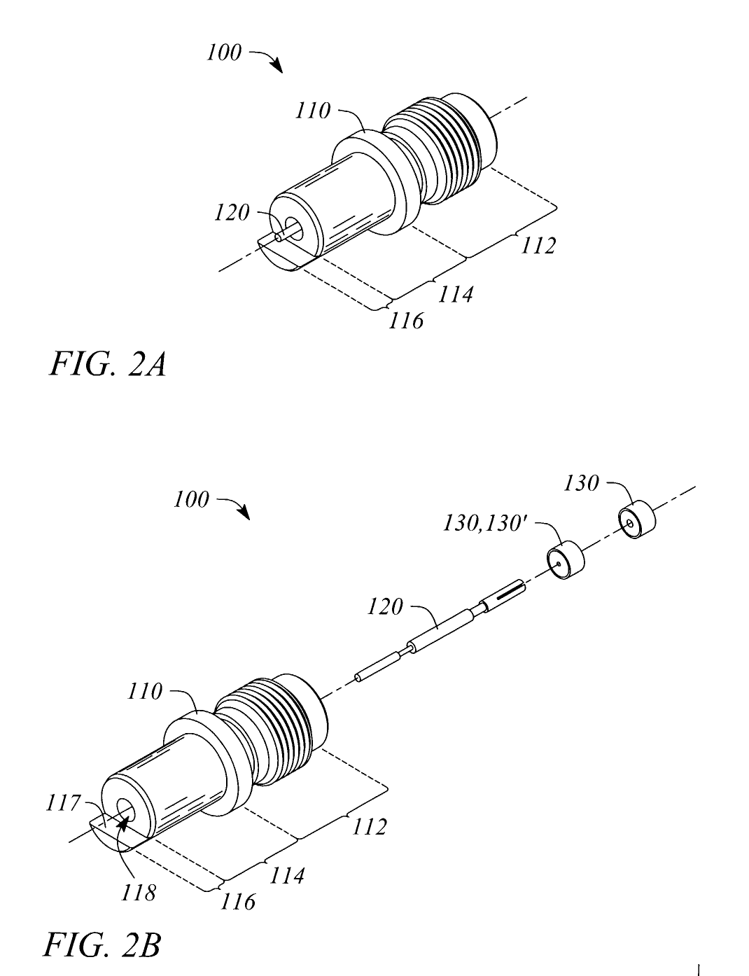

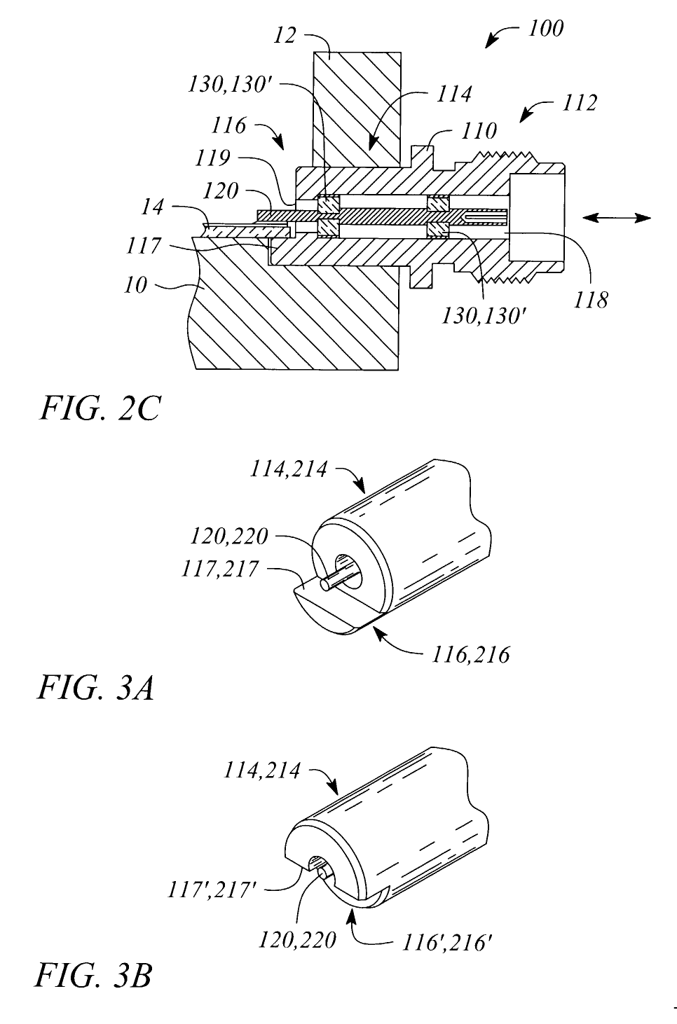

FIG. 2A illustrates a perspective view of an embodiment of a one-piece connector 100 according to the present invention. The connector 100 is an axially adjustable, high frequency coaxial connector. By high frequency it is meant that the connector is capable of transmitting signals having frequencies in the radio frequency (RF), microwave and millimeter wave frequency ranges. FIG. 2B illustrates an exploded perspective view of the one-piece connector 100 illustrated in FIG. 2A. FIG. 2C illustrates a cross-sectional view of the one-piece connector 100 of FIG. 2A installed or mounted in a package wall 12 of a microcircuit package 10.

The one-piece connector 100 comprises an electrically conductive outer shell 110 having a connector portion 112, a feed thru portion 114 and a launch portion 116. The connector portion 112 is located at a first end of the shell 110 and the launch portion 116 is located at a second end of the shell 110, which is opposite to the first end. The feed thru portion 114 is disposed between the connector portion 112 and the launch portion 116. The shell 110 has a cylindrical borehole 118 that extends through the shell 110 along a longitudinal axis of the shell 110 through the connector portion 112 and the feed thru portion 114 to the launch portion 116. The borehole 118 preferably is located at or near a center longitudinal axis of the shell 110.

The one-piece coaxial connector 100 further comprises a center pin 120 and a pin support 130. The center pin 120 is electrically conductive and is located in and extends along the length of the cylindrical borehole 118. The center pin 120 extends out of the borehole 118 beyond a distal end 119 of the feed thru portion 114 into the adjacent launch portion 116, and in some embodiments, extends beyond a launch shelf 117 of the launch portion 116. The extension of the center pin 120 out of the borehole 118 beyond the distal end 119 of the feed thru portion 114 and into the launch portion 116 facilitates forming an electrical connection between a conductor trace or a transmission line of a planar circuit 14 and the connector 100, as illustrated in FIG. 2C.

The pin support 130 comprises a rigid or semi-rigid dielectric material that extends from the center pin 120 to an inner surface of the shell 110 within the borehole 118. The pin support 130 supports the center pin 120 at or near a center of the cylindrical borehole 118. In some embodiments, there may be more than one pin support 130. Also in some embodiments, a total length of the pin support(s) 130 along the center pin 120 is minimized to a total length necessary to adequately support the center pin 120. Minimizing the length of the pin support 130 reduces an effect that the support 130 has on electromagnetic wave propagation through the connector 100.

Acting together, the shell 110 and the pin 120 create a high frequency, coaxial waveguide or transmission line that supports signal propagation through the connector 100 in the form of electromagnetic waves. As a coaxial transmission line, the connector 100 nominally supports signal propagation as a transverse electromagnetic (TEM) wave. Through the connection between the center pin 120 and the planar circuit 14 transmission line, a propagating signal in the connector 100 is transferred to and allowed to propagate along the planar circuit 14 transmission line.

In some embodiments, the coaxial transmission line formed by the connector 100 is known as an ‘air dielectric’ transmission line acknowledging that a space within the borehole 118 between the center pin 120 and the shell 110 is filled by a gas, nominally air, except in the vicinity of the pin support 130. An air dielectric transmission line, or ‘air-line’, is typically employed in coaxial transmission line applications where low loss is either desired or required. A typical situation for the use of an air-line connector 100 occurs when dealing with wave propagation in the upper microwave and millimeter wave frequency ranges. As such, the one-piece connector 100 with an air dielectric is applicable to TEM propagation at frequencies from DC (i.e., 0 Hz) to frequencies well in excess of 200 GHz.

The pin support 130 may be realized or implemented using a hermetic seal assembly 130′, an embodiment thereof being described in more detail hereinbelow. Using the hermetic seal assembly 130′ enables the pin support 130′ to function as a hermetic interface between an environment inside the package 10 and an environment outside the package 10. While one or more pin supports 130′ may be used in a single connector, preferably only one of the pin supports 130′ provides the hermetic interface or seal. More preferably, pin supports 130 are employed except where the hermetic interface is desired and achieved using the seal assembly 130′.

In other embodiments, the space within the borehole 118 may be filled with a low-loss dielectric material such as, but not limited to Teflon®. Teflon® is a trade name for polytetrafluoroethylene (PTFE), registered to E. I. Du Pont De Nemours and Company Corporation, 101 West 10th St., Wilmington, Del., 19898. While the connector 100 having the borehole 118 space filled with a dielectric material can sometimes be used at very high frequencies, loss associated with the dielectric, as well as other factors, typically limits such non air-line connectors 100 embodiments to use at frequencies below about 40 GHz.

The connector portion 112 of the shell 110 enables the connector 100 to be connected to a mating coaxial connector (not illustrated) that is external to the microcircuit package 10. Such a mating connector may be found on an end of a semirigid coaxial cable, for example. The connector portion 112 may be either a ‘female’ connector or a ‘male’ connector according to the present invention. The connector portion 112 is illustrated in FIGS. 2A-2C as a female connector, for explicatory purposes only. Moreover, the connector portion 112 may conform to any standard or non-standard RF or microwave coaxial connector configurations known in the art. For example, the connector portion 112 may be configured as any one of the standard microwave coaxial connector configurations including, but not limited to, an SMA connector, a 3.5-mm connector, a 2.4-mm connector, a 1.85-mm connector, a 1.0-mm connector and a 0.6-mm connector. One skilled in the art is familiar with a wide variety of such connector configurations and may readily realize the connector portion 112 according to the present invention in any of the connector configurations known in the art without undue experimentation.

The feed thru portion 114 of the shell 110 is at least as long as, and preferably longer than, a maximum thickness of the package wall 12 into which the connector 100 is to be installed or mounted. For example, the feed thru portion 114 may be 6-mm in length and be used in a package wall 12 having a thickness up to about 5.9 mm. Furthermore, the feed thru portion 114 has a smooth outer surface extending along the length of the feed thru portion 114. In particular, the feed thru portion 114 has no protrusions or other features extending beyond a mean maximum dimension of the outer surface (i.e., smooth), such that the protrusions or features would prevent or hinder an adjustable insertion of the connector 100, up to the total length of the feed thru portion 114, into an appropriately sized borehole in the package wall 12. An appropriately sized borehole in the package wall 12 is a borehole having a minimum dimension sufficient to receive and to provide clearance therethrough for the feed thru portion 114 of the one-piece connector 100.

In some embodiments, the feed thru portion 114 is cylindrical and the mean maximum dimension of the outer surface is a mean diameter of the cylinder. In such embodiments, the borehole in the package wall 12 is a cylindrical borehole, the minimum dimension of which is a clearance diameter for the mean diameter of the cylindrically shaped feed thru portion 114. While the feed thru portion 114 is described herein as having a cylindrical shape, it is within the scope of the present invention for the feed thru portion 114 to have other cross-sectional shapes, such as rectangular or elliptical, for example. Never the less, in all embodiments, the feed thru portion 114 has a smooth outer surface allowing the connector 100 to be axially adjusted by sliding the connector into position during installation.

While precluding ‘hindering’ protrusions and features beyond a mean diameter, the use of the term ‘smooth’ herein with respect to the outer surface of the cylindrical feed thru portion 114 specifically allows imperfections, and especially for depressions, formed in the outer surface according to the present invention. In particular, a depression, such as may be used for accepting an end of a setscrew or an epoxy plug for securing the connector 100 in the package wall 12, may be present in the smooth cylinder surface according to some embodiments. In other embodiments, an annular depression around a circumference of the cylindrical outer surface of the feed thru portion 114 may be employed without rendering the cylinder ‘unsmooth’ according to the present invention. Such an annular depression may be provided for accepting and holding a ring gasket used for sealing an interface between the connector 100 and the borehole in the package wall 12, for example. Alternatively, such a depression in the surface of the feed thru portion 114 may be used to hold a ring gasket in the form of a solder ‘preform’ that, once re-flowed or melted during connector 100 installation, both secures the connector 100 in the wall 12 and seals a mechanical interface between the wall 12 and the connector 100.

The smooth cylindrical outer surface of the feed thru portion 114 also imparts to the connector 100 the aforementioned axial adjustability. In particular, the feed thru portion 114 having a length that preferably exceeds the thickness of the package wall 12 enables the connector 100 to be positioned axially along the length during connector 100 installation. A difference between the total length of the feed thru portion 114 and the package wall 12 thickness determines an overall adjustability of the connector 100. In other words, the connector 100 is inserted into the package wall 12 borehole during connector 100 installation and the length of the feed thru portion 114 enables the connector 100 to be adjusted axially. The connector 100 may be axially adjusted until, for example, a mounting end of the center pin 120 and/or a location of the launch portion 116 are positioned optimally with respect to connecting to the planar circuit 14 inside the package 10. Such axial adjustability enables the connector 100 to account for tolerance build-up associated with the planar circuit 14 within the package 10, for example. Referring to FIG. 2C, a double-headed arrow indicates the axial adjustability of the connector 100 afforded by the overall length and smooth outer surface of the feed thru portion 114 of the shell 110 according to the present invention.

As mentioned hereinabove, the launch portion 116 is located at a distal end 119 of the shell 110 with respect to the connector portion 112. The launch portion 116 provides a mechanical and electrical interface between the connector and the planar circuit 14 within the microcircuit package 10. In particular, the launch portion 116 in conjunction with the aforementioned connection between the extended center pin 120 and the planar circuit 14 transmission line helps to ‘launch’ the propagating electromagnetic wave from the connector 100 onto the planar circuit 14. Thus, the launch portion 116 may be shaped to optimize an electrical interface between the TEM wave propagation mode within the connector 100 and one or more propagation modes of the planar circuit 14.

In particular, the launch portion 116 may provide for a high-quality ground connection between the connector 100 and the circuit 14. FIG. 3A illustrates an exemplary launch portion 116 that extends from the feed thru portion 114 and that facilitates a ground connection for a planar circuit 14 having a ‘backside’ or ‘bottomsurface’ ground plane, such as is used with a microstrip transmission line-based planar circuit 14. Specifically, the exemplary launch portion 116 illustrated in FIG. 3A has a lip or extended shelf 117 that protrudes from the distal end 119 to extend under the planar circuit 14 in the package 10, as illustrated in FIG. 2C. The shelf 117 electrically connects to the backside ground plane of the planar circuit 14, thereby ensuring a high quality ground connection.

Similarly, FIG. 3B illustrates an example of a launch portion 116′ adapted for use with a planar circuit 14 having a ‘top-surface’ or ‘frontside’ ground plane, such as a planar circuit 14 that employs a coplanar waveguide. The exemplary launch portion 116′ illustrated in FIG. 3B has an extended shelf 117′ that protrudes from the distal end 119 of the feed thru portion 114 to extend over the planar circuit 14 when the connector 100 is installed in the microcircuit package 10. Similar to the shelf 117 that connects with the backside ground plane, the shelf 117′ electrically connects with the frontside ground plane.

In other embodiments (not illustrated), the launch portion comprises both a frontside shelf 117′ and a backside shelf 117. Such embodiments of the launch portion may provide an electrical connection to a planar circuit 14 having one or both of a frontside ground plane and a backside ground plane. Additionally, the launch portion 116, 116′ and more specifically the shelf 117, 117′ may be shaped to optimize the electrical connection, or more particularly an impedance match, between the connector 100 and planar circuit 14. Thus, the launch portion 116, 116′ facilitates a low-loss, high quality transmission line interface between the connector 100 and the planar circuit 14 in the microcircuit package 10.

The electrical connection between the shelf 117, 117′ and the respective ground plane(s) may be provided by direct mechanical frictional contact between the shelf 117, 117′ and the ground plane. Preferably however, the electrical connection may employ some means of electromechanical bonding including, but not limited to, the use of a conductive epoxy, a solder, another similar eutectic bonding material, or a weld or braze. Electro-mechanical bonding ensures that the electrical connection exhibits good electrical continuity, thereby reducing ohmic loss associated with the connection. In addition as mentioned above, adaptations of the launch portion 116, 116′ to improve the impedance match between the connector 100 and the planar circuit 14 are within the scope of the present invention. One skilled in the art is familiar with many such adaptations known in the art, all such adaptations being within the scope of the present invention.

As mentioned hereinabove, axial adjustment of the one-piece connector 100 according to the present invention enables a connection end of the center pin 120 extending out of the borehole 118 beyond the distal end 119 of the shell 110 into the launch portion 116 of the connector 100 to be optimally positioned with respect to connecting to features (e.g., transmission lines) of the planar circuit 14. For example, a micrometer stage may be used to position and hold the connector 100 in the package wall 12 borehole during axial adjustment and position optimization. Once positioned, the connector 100 may be fixed in place. In particular, the connector 100 may be fixed in place in a manner that provides a hermetic seal between the connector 100 and the package wall 12, as well as other non-hermetic seals.

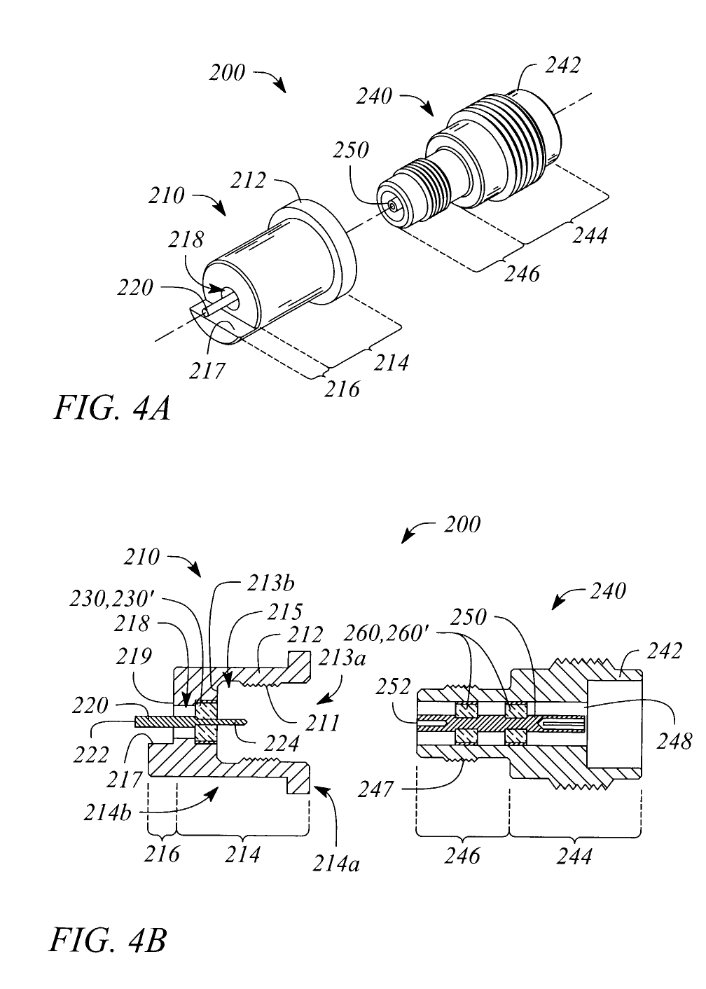

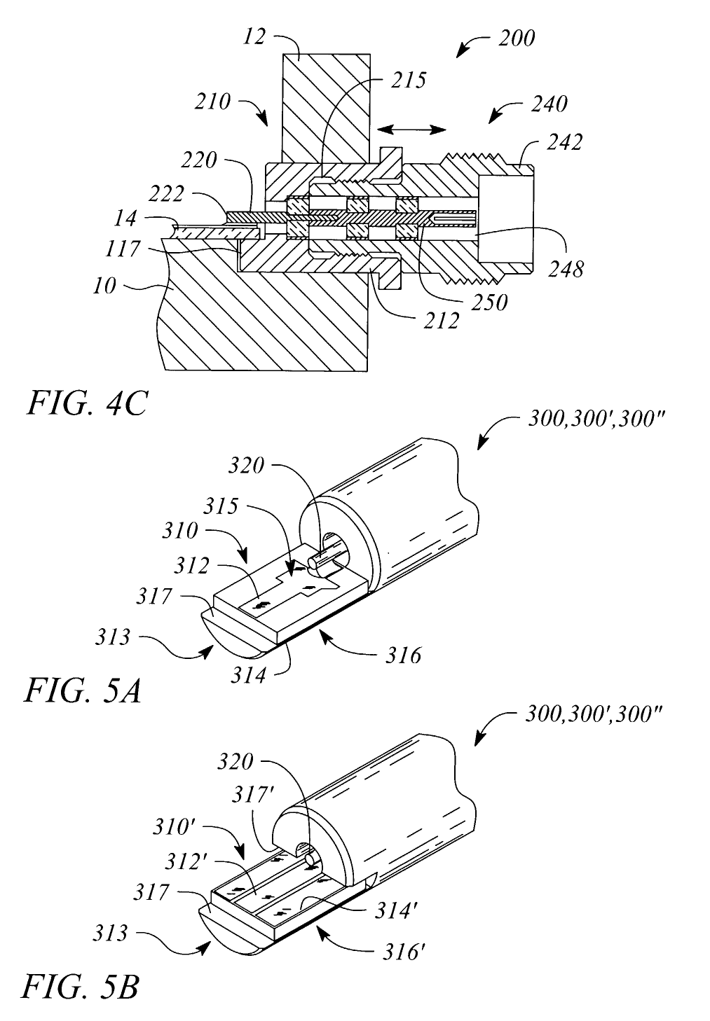

FIG. 4A illustrates a perspective view of an embodiment of a two-piece connector 200 according to the present invention. The two-piece connector 200 is an axially adjustable, high frequency coaxial connector. The two-piece connector 200 comprises a feed thru sleeve 210 and a connector assembly 240. The feed thru sleeve 210 has a receptacle that receives the connector assembly 240 thus forming a complete two-piece connector 200. In a preferred embodiment, the connector assembly 240 screws into the receptacle of the feed thru sleeve 210, as is further described below. FIG. 4B illustrates a cross-sectional view of an embodiment of the feed thru sleeve 210 and the connector assembly 240. FIG. 4C illustrates a cross-sectional view of an embodiment of the two-piece connector 200 installed or mounted in a package wall 12 of a microcircuit package 10. Much of the discussion herein regarding materials, manufacture, and advantages of the one-piece connector 100 applies equally well to the two-piece connector 200 except as noted hereinbelow and as is readily apparent to one skilled in the art.

Referring to FIGS. 4A and 4B, the feed thru sleeve 210 comprises an electrically conductive sleeve shell 212 that comprises a feed thru portion 214 and a launch portion 216. The feed thru portion 214 extends from a first end of the sleeve 210 to the launch portion 216 located at a second or distal end of the sleeve 210. An outer surface of the shell 212 along the feed thru portion 214 is a smooth cylinder, as is described hereinabove with respect to the feed thru portion 114 of the one-piece connector 100. In some embodiments, the feed thru portion 214 may comprise a lip 214a at or adjacent to the first end of the sleeve 210 and a smooth cylindrical portion 214b making up a balance of a length of the feed thru portion 214. In other words, the smooth cylindrical portion 214b extends from the lip 214a to the launch portion 216 of the sleeve 210. The lip 214a typically has a mean diameter that is greater than a mean diameter of the smooth cylindrical portion 214b. A length of the feed thru portion 214, in particular a length of the smooth cylindrical portion 214b, is at least equal to a thickness, and preferably greater than the thickness, of a package wall 12 into which the sleeve 210 is installed, as was described with respect to the feed thru portion 114 of the one-piece connector 100. Also, as with the feed thru portion 114 of the connector 100, a smooth but non-cylindrical shape of the feed thru portion 214 is within the scope of the present invention.

The launch portion 216 of the sleeve shell 212 is equivalent to the launch portion 116, 116′ described hereinabove with respect to the one-piece connector 100. In particular as described hereinabove for the launch portion 116, 116′ of the connector 100, the launch portion 216, 216′ may provide for one or both of a connection to a frontside or backside ground plane of the planar circuit 14. For example, the launch portions 116, 116′ illustrated in FIGS. 3A and 3B or a combination thereof (not illustrated) may be adapted to and used as the launch portion 216, 216′ of the feed thru sleeve 210. As with connector 100, the launch portion 216, 216′ of the connector 200 facilitates an optimized ground connection between the connector 200 and the planar circuit 14, among other things. Thus, FIGS. 3A and 3B illustrate examples of launch portions 116, 116′ for the one-piece connector 100 as well as examples of launch portions 216, 216′ that apply to the two-piece connector 200. Referring again to FIGS. 4A and 4B, an example of the shelf 217 is illustrated with the launch portion 216.

The sleeve shell 212 has a cylindrical internal cavity 215 with a depth that is less than the length of the feed thru portion 214. The cavity 215 has an entrance 213a at the first end of the shell 212 that receives the connector assembly 240 and a stop 213b at an end of the cavity 215 opposite to the entrance 213a. In some embodiments, the cavity or receptacle 215 has screw threads 211 formed in an inner wall of the shell 212 within the cavity 215. In such embodiments, when the connector assembly 240 is screwed into the sleeve 210, the threads 211 of the cavity 215 cooperatively engage threads 247 of the connector assembly 240 to mechanically and electrically connect the connector assembly 240 to the sleeve 210. The sleeve shell 212 further has a cylindrical borehole 218 that extends along a center axis of the shell 212 from the stop end 213b of the cavity 215 to the distal end 219 of the feed thru portion 214 adjacent to the launch portion 216.

The feed thru sleeve 210 further comprises a center pin 220 and a pin support 230. The center pin 220 is located coaxially along the center axis of the shell 212 and preferably extends out of the borehole 218 beyond the distal end 219 of the feed thru portion 214 into the launch portion 216. The extension of the pin 220 beyond the distal end 219 of the feed thru portion 214 facilitates forming an electrical connection between the conductor trace or the transmission line of the planar circuit 14 and the two-piece connector 200. As with the connector 100, a space created within the borehole 218 of the sleeve shell 212 is preferably air-filled such that the center pin 220 functions as a center conductor of a coaxial air-line transmission line formed by the center pin 220 and borehole 218. In particular, the air-line of the feed thru sleeve 210 facilitates using the two-piece connector 200 for frequencies from DC to frequencies in excess of 200 GHz.

The pin support 230 supports the center pin 220 in the borehole 218 of the sleeve shell 212. The pin support 230 is essentially the same as the pin support 130 described hereinabove with respect to the connector 100. Thus, the pin support 230 comprises a rigid or semi-rigid dielectric material that supports the pin 220 in the borehole 218. As with the pin support 130 of the connector 100, the pin support 230 may be replaced with a seal assembly 230′ in certain embodiments, as is further described in more detail below. In particular, the seal assembly 230′ in a preferred embodiment of the two-piece connector 200 may provide a hermetic seal interface within the borehole 218 between the feed thru sleeve shell 212 and the center pin 220. Furthermore, if the sleeve 210 is affixed to the package wall 12 in a manner consistent with providing a hermetic seal between the sleeve 210 and the wall 12, such as by soldering or brazing, as described further above, the sleeve 210 seal acting in conjunction with the seal assembly 230′ may provide a hermetic interface between the connector 200 and the package wall 12 of the microcircuit package 10.

The connector assembly 240 comprises connector shell 242 having a connector portion 244 and a mating portion 246. In some embodiments, the connector portion 244 is essentially identical to the connector portion 112 of the one-piece connector 100. Specifically, the connector portion 244 may conform to any standard or non-standard RF or microwave coaxial connector configuration known in the art. For example, the connector portion 244 may be realized as any one of the standard microwave coaxial connector configurations including, but are not limited to, an SMA connector, a 3.5-mm connector, a 2.4-mm connector, 1.85-mm connector, 1.0-mm connector and a 0.6-mm connector.

In some embodiments, the mating portion 246 comprises threads 247 formed in an outer surface of the mating portion 246. The threads 247 cooperatively engage the threads 211 of the receptacle cavity 215 of the sleeve shell 212 when the connector assembly 240 is inserted into the sleeve 210. The cooperatively engaged threads serve to mechanically secure the connector assembly 240 to the feed thru sleeve 210 as well as provide an electrical connection between the shell 242 of the connector assembly 240 and the shell 212 of the feed thru sleeve 210. Moreover, the threads of the mating portion 246 removably connect the connector assembly 240 to the sleeve 210 enabling the connector assembly 240 to be repeatedly connected to and removed from the feed thru sleeve 210, as desired.

The connector assembly 240 further comprises a center pin 250 and one or more pin supports 260 that support the center pin 250. The connector shell 242 has a borehole 248 that extends along a longitudinal axis of the connector assembly 240 through the mating portion 246 at a first end and through most of the connector portion 244 at a second, opposite end of the connector assembly 240. The center pin 250 and pin support(s) 260 are located in the borehole 248, the center pin being supported by the pin supports 260 at or near a center axis of the borehole 248. The center pin 250 extends the length of the borehole 248 from the first end to adjacent the second opposite end of the connector assembly 240. The center pin 250 is adapted to receive and electrically connect to the center pin 220 of the feed thru sleeve 210 when the connector assembly 240 is inserted into the sleeve 210 cavity 215. One skilled in the art is familiar with a variety of means for electrically connecting center pins of coaxial connectors. All such means are within the scope of the present invention with respect to connecting the center pin 250 with the center pin 220.

A space within the borehole 248 is preferably air-filled such that the center pin 250 and the borehole 248 form an air-line that supports TEM electromagnetic wave propagation, as described above. In particular, the air-line of the connector assembly 240 facilitates using the two-piece connector 200 for frequencies from DC to frequencies in excess of 200 GHz, as described above for connector 100.

Moreover as was described with respect to the one-piece connector 100, the smooth cylindrical portion 214b of feed thru portion 214 of the sleeve shell 212 imparts to the connector 200 the aforementioned axial adjustability. In particular, the cylindrical portion 214b of the feed thru portion 214 having a length that equals or preferably exceeds the thickness of the package wall 12 enables the connector 200 to be positioned axially along its length during installation in the wall 12. A difference between the total length of the cylindrical portion 214b and the package wall 12 thickness determines an overall axial adjustability. In other words, when the connector 200 is inserted into the package wall 12 borehole during installation, for example, the connector 200 is adjusted axially until, for example, a mounting end of the center pin 220 and/or the launch portion 216 of the shell 212 are located optimally with respect to a planar circuit 14 inside the package 10. Referring to FIG. 4C, a double-headed arrow indicates the axial adjustability of the connector 200 that is afforded by the overall length and smooth outer surface of the cylindrical portion 214b of the feed thru portion 214 of the sleeve shell 212.

The two-piece connector 200 embodiments of the present invention provide for different approaches to assembly with a microcircuit package 10. In a first approach, the connector assembly 240 is inserted into the feed thru sleeve 210 and then this assembled connector 200 is installed in the package wall 12 borehole for connection to the planar circuit 14 in the package 10. In a second approach, the feed thru sleeve 210 is installed into the package wall 12 borehole before the connector assembly 240 is inserted into the sleeve 210. In the second approach, the feed thru sleeve 210 can be connected to the planar circuit 14 either before or after the connector assembly 240 is inserted. Thus, either the assembled two-piece connector 200 or the sleeve 210 of the connector 200 may be axially adjusted during the connector 200 installation to precisely position the center pin 220 in an optimal manner with respect to features of the planar circuit 14. Once positioned, the feed thru sleeve 210 can be attached to the package wall 12 to provide a hermetic or other desired type of seal between the package wall 12 and the sleeve 210, for example. If a seal assembly 230′ is employed in the sleeve 210, a hermetic seal across the package wall 12 may be achieved provided that the sleeve 210 is fixed in the package wall 12 in a manner consistent with providing a hermetic seal. The connector assembly 240 is removably connected to the feed thru sleeve 210, as mentioned hereinabove. Advantageously, the seal achieved between the package wall 12 and the feed thru sleeve 210, including the hermetic type seal, need not be broken to remove and replace the connector assembly 240. Moreover, other connector assemblies 240 having different connector configurations may be interchangeably connected to the feed thru sleeve 210, in particular, without disrupting the seal.

The shell 110, the sleeve shell 212, and the connector shell 242 are preferably fabricated from a conductive material. More preferably, a conductive material, such as a metal that is readily machined, is employed to facilitate fabrication of the various portions of the shell 110, 212, 242. For example, a metal such as, but not limited to, Stainless Steel, Iron-Nickel, Copper, Tungsten or Brass, or any other metal conventionally used in fabricating high frequency coaxial connectors may be used. Alternatively, the shell 110, 212, 242 may be fabricated from a non-conductive material. When a non-conductive material is employed, a conductive coating is deposited on a surface of the shell 110, 212, 242 during fabrication.

For high frequency applications of the one-piece connector 100 and/or the two-piece connector 200, especially above about 1 GHz, an outer surface of the shell 110, 212, 242, as well as an inner surface of the shell 110, 212, 242 created by the borehole 118, 218, 248, are preferably plated with a material, such as Gold (Au), to improve conductivity and control or minimize corrosion. In some embodiments, additional plating layers are applied before the Gold (Au) layer is applied to facilitate adhesion or improve plating reliability. For example, the shell 110, 212, 242 may be plated with an undercoat of Nickel (Ni) prior to being plated with Gold (Au).

The use of plating for improving conductivity (i.e., decreasing ohmic loss) and/or for controlling corrosion in high frequency coaxial connectors is well known to one skilled in the art. A choice of the conductive material for the shell 110, 212, 242 and/or the use of a particular type of plating are not intended to limit the scope of the present invention. One skilled in the art is familiar with a wide range of materials used for fabricating and/or plating high frequency connectors that are suitable for use in fabricating the shell 110, 212, 242 of the present connectors 100, 200. All such materials and platings are within the scope of the present invention.

As mentioned hereinabove, a main criterion for choosing the dielectric material for the pin supports 130, 230, 260 of the one-piece connector 100 and the two-piece connector 200 is whether or not the material can adequately support the center pin 120, 220, 250 while simultaneously producing a minimal loss in, or disruption of, the TEM wave propagating through the connector 100, 200. Dielectric materials including, but not limited to, Borosilicate glass and Teflon® may be used for the pin support 130, 230, 260. Teflon® is a material commonly used for applications that do not require a hermetic seal at the pin support 130, 230, 260.

In some embodiments of the present invention, the one-piece connector 100 and/or two-piece connector 200 may act as hermetic connector and provide a hermetic interface across the wall 12 of the microcircuit package 10, as mentioned hereinabove. In such embodiments, the pin support 130, 230 is a seal assembly 130′, 230′ employing means for providing a hermetically sealed interface. For example, a seal assembly 130′, 230′ may employ a sintered glass frit such as, but not limited to, Borosilicate glass as the dielectric material. Alternatively, the seal assembly 130′, 230′ may employ another dielectric material or combination of materials including, but not limited to, an Alumina ceramic and various glass-ceramic materials such as Macor™. Macor™ is a trademark for unworked or semi-worked glass-ceramic materials, registered to Corning Glass Works, Houghton Park, N.Y., 14830. The combination of the shell 110, 210 and the seal assembly 130′ 230′ when mounted in the package wall 12 form a gas tight interface, or preferably a hermetic interface, across the package wall 12. The use of seals for forming a hermetic high frequency feed thru in RF and microwave connectors is well known in the art.

In general, seal assemblies known in the art may be classified loosely as either matched dielectric-to-metal seals or compression dielectric-to-metal seals. As mentioned hereinabove, references to ‘dielectric-to-metal’ and ‘frit’ with respect to the seal assemblies 130′, 230′ are intended to include all dielectric materials that are employed to produce a hermetic interface. The term ‘matched’ in this case refers to the matching of a coefficient of thermal expansion (CTE) of various materials used in fabricating the seals. In essence, the glass and metal components of the seal are selected to have approximately equal CTEs. Examples of matched dielectric-to-metal seals are disclosed by Smith, U.S. Pat. No. 4,445,920; Bandyopadhyay et al., U.S. Pat. No. 4,888,037; and Szwec, U.S. Pat. No. 5,563,562, all of which are incorporated herein by reference. For compression dielectric-to-metal seals, the dielectric and metal component materials are chosen such that once fabricated, the dielectric portion is placed under compression. Examples of compression dielectric to-metal seals are disclosed by Naugler et al., U.S. Pat. No. 5,709,724; Box, U.S. Pat. No. 4,430,376; Saffari, U.S. Pat. No. 4,915,719; Simpson, U.S. Pat. No. 4,128,697; Kellerman et al., U.S. Pat. No. 4,587,144; Layher, U.S. Pat. No. 4,678,358; and Kyle, U.S. Pat. No. 4,493,378, all of which are incorporated herein by reference.

The seal assembly 130′, 230′ used to achieve a hermetic interface within the one-piece connector 100 and the two-piece connector 200 may be either fabricated separately from the connector 100, 200 and then soldered or otherwise affixed into the connector 100, 200 or may be formed by a fusing operation directly into the connector 100, 200. Generally, the seal assembly 130′, 230′ incorporates the center pin 120, 220 and comprises a metal ring and the frit. An oxide formed on an inside surface of the metal ring and on a portion of the center pin 120, 220 enables the frit to form a ‘molecular’ bond to the center pin 120, 220 and the metal ring. When the seal assembly 130′, 230′ is fabricated separately, the metal ring provides an outer surface that may be bonded, for example using soldering, to an inner surface of the shell 110, 212 created by the borehole 118, 218. Alternatively, the borehole 118, 218 of the shell 10, 212 may replace the metal ring and the frit is bonded directly between the center pin 120, 220 and the inner surface of the shell 10, 212 to form the seal assembly 130′, 230′.

In general, the pin support 260 of the connector assembly 240 also may be a seal assembly 260′. However, since the hermeticity of the two-piece connector 200 is preferably achieved by the feed thru sleeve 210 having a seal assembly 230′, use of a seal assembly 260′ is typically not preferred for the connector assembly 240 except in certain application where mechanical or environmental stresses warrant such a use.

In yet other embodiments, the pin support 130, 230, 260 may be dispensed with altogether by filling the borehole 118, 218, 248 with a preferably low loss, dielectric material such as Teflon® (PTFE), as mentioned herein above. In essence, the entire length of the borehole 118, 218, 248 becomes the support 130, 230, 260 for the center pin 120, 220, 250. While use of a dielectric material, such as PTFE, increases loss, satisfactory performance in terms of loss still may be achieved at frequencies in excess of 40 GHz with a dielectric-filled borehole 118, 230, 248.

The center pin 120, 220, 250 is a conductor, preferably a metal. For example, the center pin 120, 220, 250 may be fabricated from a metal such as, but not limited to, KOVAR™, Tungsten or Molybdenum preferably plated with Gold (Au). KOVAR™, a registered trademark for a nickel-cobalt-iron alloy, is registered to Westinghouse Electric & Manufacturing Company, Pittsburgh, Pa. In particular, Tungsten or Molybdenum generally possess a high strength enabling them to survive fabrication and repeated mating and un-mating during operational use of the connector 100, 200. In addition, both Tungsten and Molybdenum are known to form a thick, uniform oxide appropriate for sealing with respect to the seal assembly 130′, 230′, 260′, as described hereinabove. Preferably, the center pin 120, 220, 250 is Gold (Au) plated along the entire length of the pin 120, 220, 250, excluding a portion in the vicinity of the pin support 130, 230, 260 when a seal assembly 130′, 230′, 260′ is used. While several suitable metal materials are listed for the center pin 120, 220, 250 hereinabove by way of example, the listed exemplary materials are not intended to limit the scope of the present invention in any way.

In another aspect of the invention, a coaxial connector 300 having an integrated launch substrate is provided. In some embodiments, the coaxial connector 300 may be implemented as the one-piece connector 100 according to the present invention. In other embodiments, a connector 300′ having an integrated launch substrate may be implemented as the two-piece coaxial connector 200 according to the present invention. When the coaxial connector 300, 300′ is implemented as either the connector 100 or the connector 200, the connector 300, 300′ is an axially adjustable connector 300, 300′ with an added feature of an integrated launch substrate. In yet other embodiments, a coaxial connector 300″ having an integrated launch substrate may be implemented as a coaxial connector without the features associated with axial adjustability.

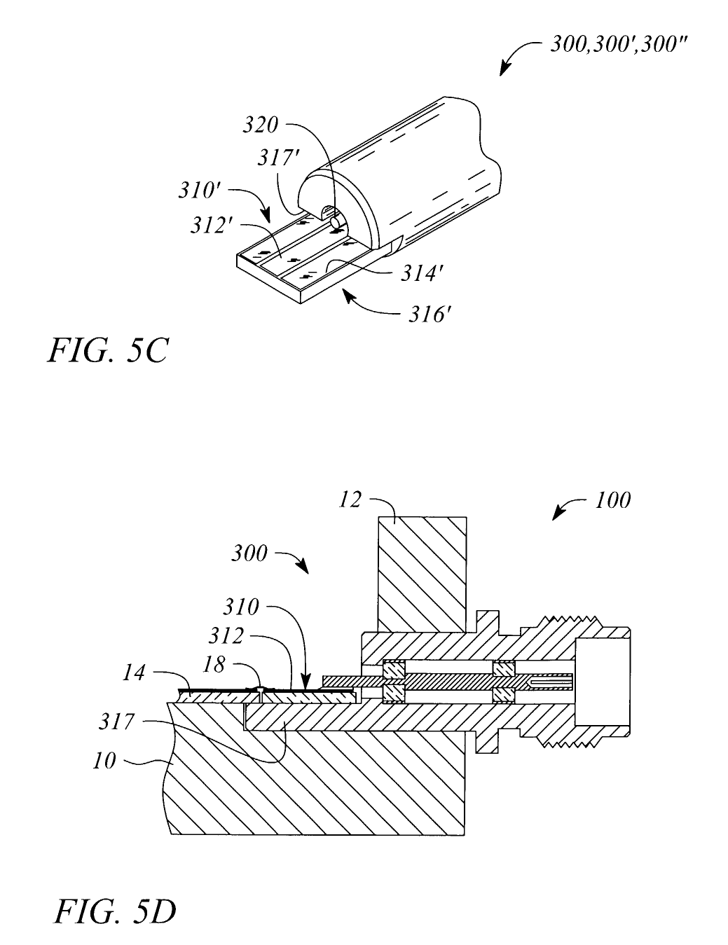

FIG. 5A illustrates an embodiment of a launch portion 316 of the coaxial connector 300, 300′, 300″ comprising an exemplary integrated launch substrate 310 according to the present invention. In particular, the exemplary embodiment of the launch portion 316 comprising the integrated launch substrate 310 illustrated in FIG. 5A is adapted for use with a planar circuit 14 (not illustrated in FIG. 5A) having a backside ground plane, such as a microstrip-based circuit 14. The launch portion 316 comprises an extended shelf 317. The extended shelf 317 is similar to the shelf 117, 217 of the launch portion 116, 216 described hereinabove except that the extended shelf 317 is adapted for mounting and supporting the integrated launch substrate 310. The extended shelf 317 is so adapted at least by being longer than the shelf 117, 217 to sufficient mount and support the integrated launch substrate 310.

The integrated launch substrate 310 is a planar circuit substrate mounted to and supported by the extended shelf 317. The integrated launch substrate 310 comprises a conductive trace or transmission line 312 on the planar substrate 310. The transmission line 312 connects to a center pin 320 of the connector 300, 300′, 300″. The launch substrate 310 further comprises a backside ground plane 314. The backside ground plane 314 is electrically connected to the shelf 317 when the substrate 310 is mounted to the shelf 317. In some embodiments such as the embodiment illustrated in FIG. 5A, a distal end 313 of the extended shelf 317 may extend beyond the integrated launch substrate 310, thereby facilitating a high quality backside ground connection to the planar circuit 14 in a package 10 in the manner previously described with respect to the shelf 117, 217.

In other embodiments (not illustrated), the integrated launch substrate 310 may overhang or extend beyond the distal end 313 of the extended shelf 317. In such embodiments, a high quality backside ground connection may be realized by attaching a backside ground plane of the overhanging integrated launch substrate 310 to a package floor or other ground interface within the package 10 and/or associated with the planar circuit 14.

The integrated launch substrate 310 optionally may further comprise matching circuitry 315 illustrated conceptually in FIG. 5A. The matching circuitry 315 optimizes an electromagnetic wave transmission response or impedance match of an electrical interface between the integrated launch substrate 310 and a coaxial portion of the connector 300, 300′, 300″. Specifically, the integrated launch substrate 310 facilitates a transition of an electromagnetic wave from a propagating mode of the coaxial portion to a propagating mode of the planar circuit 14 (not illustrated). As such, the integrated launch substrate 310 effectively ‘launches’ the wave onto the planar circuit 14. One skilled in the art is familiar with matching circuitry 315, its design and its implementation. All such matching circuitry and means for designing and implementing the matching circuitry for use on the integrated launch substrate 310 are within the scope of the present invention.

FIG. 5B illustrates another embodiment of a launch portion 316′ of the coaxial connector 300, 300′, 300″ comprising an integrated launch substrate 310′. In particular, the exemplary launch portion 316′ and launch substrate 310′ illustrated in FIG. 5B are adapted for use with a planar circuit 14 (not illustrated in FIG. 5B) having one or both of a frontside and a backside ground plane, such as a coplanar waveguide-based circuit. The launch portion 316′ comprises the extended shelf 317 adapted for mounting the integrated launch substrate 310′. The launch portion 316′ further comprises a frontside shelf 317′. The frontside shelf 317′ is essentially equivalent to the frontside shelf 116′, 216′ described hereinabove with respect to the one-piece and the two-piece connectors 100, 200.

The integrated launch substrate 310′ is a planar circuit substrate that is mounted to and supported by the extended shelf 3l7. The integrated launch substrate 310′ comprises a conductive trace or transmission line 312′ on the planar substrate 310′. The transmission line 312′ connects to the center pin 320 of the connector 300, 300′, 300″. The launch substrate 310′ further comprises a frontside ground plane 314′. The frontside shelf 317′ is electrically connected to the frontside ground plane 314′ when the launch substrate 310′ is mounted to the shelf 317. The launch substrate 310′ optionally may further comprise matching circuitry (not illustrated). As with the integrated launch substrate 310, the matching circuitry of the integrated launch substrate 310′ optimizes an electromagnetic transition between the connector 300, 300′, 300″ and the planar circuit 14.

As was described with respect to the embodiment illustrated in FIG. 5A, the distal end 313 of the extended shelf 317 of the embodiment illustrated in FIG. 5B may either extend beyond the integrated launch substrate 310′ (as illustrated) or not extend beyond the launch substrate 310′ (not illustrated). Moreover, the shelf 317 may be omitted entirely and the launch substrate 310′ may be attached to and supported by the frontside shelf 317′ and still be within the scope of the present invention. For example, FIG. 5C illustrates such an embodiment in which the shelf 317 is omitted and the launch substrate 310′ is mounted to and supported by the frontside shelf 317′. Suspended coplanar waveguide is an example of when omission of the shelf 317 is preferred.

FIG. 5D illustrates an exemplary connector 300 embodiment comprising the integrated launch substrate 310 and that employs the axially adjustable one-piece connector 100 according to the present invention. Specifically, FIG. 5D illustrates a cross sectional view of the connector 300 embodiment installed in a microcircuit package 10. The connector 300 embodiment in FIG. 5D comprises the embodiment of the integrated launch substrate 310 adapted for a backside ground plane, as is illustrated in FIG. 5A. The transmission line 312 is connected to a transmission line of the planar circuit 14 using a conventional inter-circuit interconnection, such as using wire bonding, mesh bonding, or ribbon bonding. An exemplary ribbon bond 18 is illustrated in FIG. 5D connecting the transmission line 312 to the transmission line of the planar circuit 14. If a frontside ground also is present on the planar circuit 14, the integrated launch substrate 310 may include a frontside ground 314′, such as that described above for the integrated substrate 310′. As such, the connector 300 preferably comprises both shelves 317, 317′ to connect to the respective ground planes. Wire bonding and/or ribbon bonding also may be used to connect the ground planes on the integrated launch substrate 310, 310′ to the respective ground planes on the planar circuit.

The integrated launch substrate 310, 310′ may be implemented using any planar circuit fabrication technology that is compatible with RF and microwave circuits and systems. Examples of materials that may be used in fabricating the integrated launch substrate 310, 310′ include, but are not limited to, Sapphire (i.e., C-axis crystalline Sapphire), polished Alumina (e.g., 99.6% pure sintered Aluminum Oxide), Fused Silica, Beryllium Oxide, Diamond, and various high frequency printed circuit (PC) board materials, including but not limited to RT/Duroid® 4350. RT/Duroid® 4350 is a trademark of Rogers Corporation, Conn., 06263.

Transmission lines 312, 312′ and other elements of the launch substrate 310, 310′, including the matching circuitry 315, may be fabricated on the launch substrate 310, 310′ using any conventional circuit fabrication technology compatible with the substrate material being used including, but not limited to, thin film deposition, thick film printing, and PC board etching. Similarly, a choice of a particular conductor material for fabricating the transmission line 312, 312′ and matching circuitry 315 is usually dictated by a given situation. Conductor materials including, but not limited to, Gold (e.g., 99.99% pure Au), Silver (Ag), Aluminum (Al), and Copper (Cu) may be employed, for example. Moreover, virtually any transmission line technology including, but not limited to, microstrip, coplanar waveguide, grounded coplanar waverguide, suspended microstrip, stripline, suspended stripline, coplanar strip, slot line, and coax may be employed to produce the matching circuitry. In addition, lumped elements, as well as distributed elements, may be used for the matching circuitry 315.

As one skilled in the art can attest, designing and manufacturing a high performance, reliable and repeatable interface with a consistently acceptable interface transmission response at a connector-to-planar circuit 14 interface inside a microcircuit package 10 is a tedious and often difficult task, especially at high frequencies. In many cases, a very skilled designer employs a combination of advanced design and modeling tools along with empirical knowledge gained from years of experience to design matching circuitry for such interfaces. In addition to being difficult to design, testing of such interfaces during manufacture is notoriously problematic, since it is generally impossible to disassociate a performance of the planar circuit 14 from a performance of the interface at the connector.

Advantageously, the integrated launch substrate 310, 310′ of the present invention effectively decouples the interface design and testing problem, including the matching circuitry design and testing, from the overall problem of microcircuit packaging, in general, and from the planar circuit 14 design, in particular. In essence according to the present invention, the matching circuitry is designed independently of and separately from the designs of the microcircuit package 10 and the planar circuit 14. Thus, the intricate details of matching the connector to the planar circuit 14 need not concern the packaging designer and the planar circuit 14 designer. In fact, the connector 300, 300′, 300″ comprising the integrated launch substrate 310, 310′ even allows a manufacturer of the connector 300, 300′, 300″ to design, optimize, and produce the matching circuitry on the launch substrate 310, 310′ independent of a customer application of the connector 300, 300′, 300″. Thus, the connector manufacturer is able to offer a customer a ‘matched’ connector 300, 300′, 300″ freeing the customer from the task of designing the matching circuitry. As a result, the remaining interface between the integrated launch substrate 310, 310′ and the planar circuit 14 can be readily handled by the customer or its designers of the planar circuit 14. Moreover, each connector 300, 300′, 300″ comprising the integrated launch substrate 310, 310′ may be tested independently of testing the planar circuit 14 to verify proper performance of the coaxial-to-planar interface between the center pin 320 and the launch substrate transmission line 312, 312′.

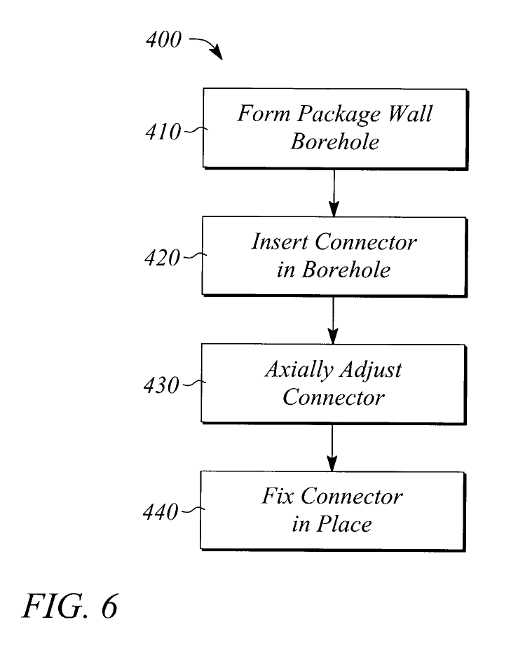

In yet another aspect of the present invention, a method 400 of axially adjusting a coaxially connector during installation in a package wall of a microcircuit package is provided. FIG. 6 illustrates a flow chart of an embodiment of the method 400 according to the present invention.

The method 400 of axially adjusting comprises forming 410 a borehole in the package wall of the microcircuit package. The borehole preferably has a constant diameter for an entire depth of the borehole. Typically, the borehole depth is at least as deep as a width of the package wall and has a diameter that provides clearance for the axially adjustable connector. The borehole may extend beyond the package wall and into a portion of a base of the package.

In some embodiments, the borehole is formed 410 in the package wall at a time of connector installation. In other embodiments, the borehole is formed at some time prior to installation of the connector. For example, the borehole may be formed prior to plating the microcircuit package such that the borehole is also plated. In particular, the package may be obtained from a package manufacturer with the borehole already formed in the package wall. Thus, the microcircuit package may be manufactured with the borehole ‘pre-formed’ for installation of a connector. When the microcircuit package has a pre-formed borehole, the forming 410 may be essentially omitted from the method 400 and still be within the scope of the present invention. Alternatively, when the borehole is pre-formed, the forming 410 can be used to render the preformed borehole an appropriate size for the axially adjustable connector, and still be within the scope of the present invention. The package borehole is formed 410 using any process known in the art. For example, the borehole may be drilled using a drill bit and/or ream. Other processes to form 410 the borehole include, but are not limited to, etching the package wall and including the borehole in a mold used to make the package. These and other methods known to those skilled in the art are within the scope of the present invention.

The method 400 further comprises inserting 420 the axially adjustable connector into the package borehole. The axially adjustable connector is preferably one of the one-piece connector 100, the two-piece connector 200, or an axially adjustable embodiment of the connector 300, 300′ comprising an integrated launch substrate, each of which is described hereinabove. In particular, the axially adjustable connector has a feed thru portion comprising a smooth cylindrical outer surface of a length that is preferably longer than the depth or thickness of the package wall and that has a mean diameter of the outer surface that is less than the diameter of the package borehole.

The method 400 further comprises axially adjusting 430 the inserted connector until the connector is optimally positioned in the package borehole. For example, the axially adjusting 430 may optimally position the connector such that a mounting end of a center pin of the connector is adjacent to and optimally positioned with respect to a planar circuit inside the microcircuit package.

The method 400 further comprises fixing 440 the axially adjusted connector in place within the package borehole. Fixing 440 may comprise any conventional means for securing a connector in a microcircuit package wall including, but not limited to, one or more of using an adhesive, such as a glue or epoxy, and using a solder at an interface between the package borehole and the connector. Soldering the connector in the package borehole is preferred if the connector is to provide a hermetic interface across the package wall of the microcircuit package. As described hereinabove, if a hermetic interface is desired, the connector further preferably incorporates a seal assembly to support the center pin in the connector. Further, when the connector is the two-piece connector 200, a feed thru sleeve may be inserted 420, adjusted 430 and fixed 440 to the package advantageously prior to inserting a corresponding connector assembly.

Thus, there has been described an axially adjustable connector and a coaxial connector with an integrated launch substrate according to exemplary embodiments. In addition, exemplary embodiments of a method of axially adjusting a coaxial connector in a microcircuit package have been disclosed. It should be understood that the above-described embodiments are merely illustrative of the some of the many specific embodiments that represent the principles of the present invention. Clearly, those skilled in the art can readily devise numerous other arrangements without departing from the scope of the present invention.

What is claimed is:

1. An axially adjustable coaxial connector for a microcircuit package comprising:
a shell having a feed thru portion,
the feed thru portion fitting through a borehole in a package wall of the microcircuit package for installation, the feed thru portion being at least as long as the package wall is thick and comprising a smooth outer surface, such that the feed thru portion is readily slideable within the borehole through the package wall to adjust an axial position of the coaxial connector.

2. The coaxial connector of claim 1, wherein the feed thru portion is longer than the package wall is thick, and wherein the smooth outer surface renders the slidability of the feed thru portion within the package wall borehole unhindered.

3. The coaxial connector of claim 1, wherein the coaxial connector is axially adjustable with respect to a planar circuit mounted in the microcircuit package, such that an axial position of the coaxial connector is readily aligned with the planar circuit.

4. The coaxial connector of claim 1, wherein the shell is a connector shell, the connector shell further having a connector portion and a launch portion, the feed thru portion being disposed between the connector portion and the launch portion, the portions being integral to each other and the connector shell being of unitary construction, such that the coaxial connector is a one-piece connector.

5. The coaxial connector of claim 1, further comprising a feed thru sleeve and a connector assembly, the feed thru sleeve comprising the shell, the connector assembly being separable from the feed thru sleeve, such that the coaxial connector is a two-piece connector.

6. The coaxial connector of claim 5, wherein the feed thru sleeve is readily slideable and axially adjustable in the package wall, the feed thru sleeve further having a sleeve cavity that receives the connector assembly.

7. The coaxial connector of claim 6, wherein the feed thru sleeve further comprises a sleeve pin coaxially disposed within a borehole in the shell, the shell borehole extending along a longitudinal axis of the shell, the sleeve pin and the shell borehole forming a coaxial transmission line through the feed thru sleeve, and wherein the connector assembly comprises a coaxially disposed connector pin that mates with the sleeve pin when received in the sleeve cavity, the mated connector pin extending the coaxial transmission line through the connector assembly.

8. The coaxial connector of claim 1, further comprising a pin coaxially disposed within a borehole in the shell, the shell borehole extending along a longitudinal axis of the shell, the pin and the shell borehole forming a coaxial transmission line through the feed thru portion, wherein the shell further has a launch portion, the launch portion extending axially from the feed thru portion, the launch portion comprising an end portion of the pin, a shelf, and a launch substrate, the launch substrate being mounted on a surface of the shelf.

9. The coaxial connector of claim 8, wherein the launch substrate has circuitry defined on a surface of the launch substrate, the launch substrate being adjacent to the pin end portion to connect the pin to the launch substrate circuitry, the launch substrate circuitry establishing a connection to circuitry on a planar circuit mounted within the microcircuit package.

10. The coaxial connector of claim 9, wherein when the coaxial connector is installed in the package wall borehole of the microcircuit package, the shelf is adjustably positioned adjacent to the planar circuit in the microcircuit package.

11. The coaxial connector of claim 9, wherein the launch substrate circuitry comprises a launch transmission line and optionally comprises matching circuitry, the pin being connected to the launch transmission line, the optional matching circuitry providing an impedance match between the coaxial transmission line of the feed thru portion and a transmission line of the planar circuit circuitry.

12. The coaxial connector of claim 11, wherein the launch substrate circuitry further comprises a ground plane, the launch substrate ground plane establishing a ground connection to a ground plane of the planar circuit circuitry.

13. The coaxial connector of claim 12, wherein the planar circuit ground plane is one or both of a backside ground plane and a frontside ground plane, the launch substrate ground plane being compatible with the planar circuit ground plane.

14. A coaxial connector comprising:
a shell having a launch portion comprising an axially extended shelf;
an integrated launch substrate mounted to and supported by the shelf, the launch substrate comprising launch circuitry defined on a surface of the launch substrate.

15. The coaxial connector or claim 14, further comprising a pin coaxially disposed within a borehole of the shell, an end portion of the pin extending axially into the launch portion, the pin end portion being connected to the launch substrate circuitry,
wherein the launch substrate circuitry is adapted for use with circuitry on a planar circuit mounted within a microcircuit package, such that when the coaxial connector is installed in a package wall of the microcircuit package, the shelf is positioned adjacent to the planar circuit to connect the launch substrate circuitry to the planar circuit circuitry.

16. The coaxial connector of claim 14, wherein the launch portion and the launch substrate provide a transition for electromagnetic wave propagation from a coaxial propagation mode within the shell to a planar propagation mode on a planar circuit mounted within a microcircuit package.

17. The coaxial connector of claim 15, wherein the launch substrate further comprising a ground plane on a surface of the launch substrate, the launch substrate ground plane being one or both of a backside ground plane and a frontside ground plane, such that when the coaxial connector is installed in the microcircuit package, the launch substrate ground plane connects a ground of the connector to a ground plane of the planar circuit.

18. The coaxial connector of claim 17, wherein the launch substrate ground plane is a backside ground plane and wherein the shelf comprises an extension that extends further axially than a length of the launch substrate, the shelf extension providing a means for connecting the backside ground plane of the launch substrate to the ground plane of the planar circuit.

19. The coaxial connector of claim 17, wherein the launch substrate ground plane is a frontside ground plane and the shelf is a frontside shelf, such that connection of the launch substrate circuitry to the planar circuit circuitry connects the launch substrate frontside ground plane to the ground plane on the planar circuit.

20. The coaxial connector of claim 14, wherein the coaxial connector is installable in a package wall of a microcircuit package, the shell further having a feed thru portion disposed adjacent to the launch portion opposite to the shelf, and
wherein the feed thru portion is longer than the package wall of the microcircuit package is thick, the feed thru portion comprising a smooth outer surface, such that when the connector is installed in the package wall, the feed thru portion is readily slideable within a borehole through the package wall to axially adjust and align the launch portion in the microcircuit package.

21. The coaxial connector of claim 20, wherein the smooth outer surface renders the slideability of the feed thru portion within the package wall borehole unhindered.

22. The coaxial connector of claim 20, wherein the coaxial connector is axially adjustable with respect to a planar circuit mounted in the microcircuit package, such that the coaxial connector is readily aligned with the planar circuit.

23. The coaxial connector of claim 20, wherein the shell is a connector shell, the connector shell further having a connector portion, the feed thru portion being disposed between the connector portion and the launch portion, the portions being integral to each other and the connector shell being of unitary construction, such that the coaxial connector is a one-piece connector.

24. The coaxial connector of claim 20, further comprising a feed thru sleeve and a connector assembly, the feed thru sleeve comprising the shell, the connector assembly being separable from the feed thru sleeve, such that the coaxial connector is a two-piece connector.

25. The coaxial connector of claim 24, wherein the feed thru sleeve is readily slideable and axially adjustable in the package wall, the feed thru sleeve further having a sleeve cavity that receives the connector assembly.

26. The coaxial connector of claim 25, wherein the feed thru sleeve further comprises a sleeve pin coaxially disposed within a borehole in the shell, the shell borehole extending along a longitudinal axis of the shell, the sleeve pin and the shell borehole forming a coaxial transmission line through the feed thru sleeve, and wherein the connector assembly comprises a coaxially disposed connector pin that mates with the sleeve pin when received in the sleeve cavity, the mated connector pin extending the coaxial transmission line through the connector assembly.

27. A method of axially adjusting a coaxially connector during installation in a package wall of a microcircuit package comprising:
inserting the coaxial connector into a borehole in the microcircuit package wall;
axially adjusting the inserted connector until a launch end of the inserted connector is positioned in the microcircuit package; and
fixing the axially adjusted connector in place within the package wall borehole.

28. The method of claim 27, further comprising:
forming the borehole through the package wall before inserting the coaxial connector, a diameter of the formed borehole being adapted to receive the coaxial connector, such that the inserted connector is adjusted by sliding the inserted connector in the formed borehole.

29. The method of claim 28, wherein forming the borehole comprises forming the borehole through the package wall adjacent to a base of the package and further forming the borehole into a portion of the package base, such that the borehole further extends into the package base portion.

30. The method of claim 27, wherein axially adjusting the inserted connector comprises sliding a feed thru portion of the inserted connector axially in the package wall borehole, the feed thru portion being axially adjacent to the launch end, the feed thru portion having a length that is at least as long as the package wall is thick, and the feed thru portion comprising a smooth outer surface, such that the feed thru portion is readily slideable in the package wall borehole.

31. The method of claim 27, wherein axially adjusting the inserted connector comprises aligning the launch end with a planar circuit mounted within the microcircuit package to achieve an optimal position.

32. A high frequency microcircuit packaging system comprising:
a microcircuit package; and
an axially adjustable coaxial connector that comprises an integrated launch substrate,
wherein the axially adjustable coaxial connector is installed in a borehole in a package wall of the microcircuit package.

33. The packaging system of claim 32, wherein the coaxial connector further comprises:
a shell having a feed thru portion, the feed thru portion being at least as long as the package wall is thick, the feed thru portion comprising a smooth outer surface, such that the feed thru portion is readily slideable within the package wall borehole to adjust an axial position of the coaxial connector.

34. The packaging system of claim 33, wherein the coaxial connector further comprises:
a pin coaxially disposed within a borehole in the shell, the shell borehole extending along a longitudinal axis of the shell, the pin and the shell borehole forming a coaxial transmission line through the feed thru portion; and
a pin support,
wherein the pin support insulatively supports the pin within the shell borehole.

35. The packaging system of claim 34, wherein the coaxial connector is installed in the package wall with a hermetic seal, the pin support being a seal assembly that forms a hermetic seal between the pin and the shell within the coaxial connector.

36. The packaging system of claim 33, wherein the shell of the axially adjustable coaxial connector is a connector shell, the connector shell further having a connector portion and a launch portion, the feed thru portion being disposed between the connector portion and the launch portion, the portions being integral to each other and the connector shell being of unitary construction, such that the coaxial connector is a one-piece connector.

37. The packaging system of claim 33, wherein coaxial connector further comprises a feed thru sleeve and a connector assembly, the feed thru sleeve comprising the shell, the connector assembly being separable from the feed thru sleeve, such that the coaxial connector is a two-piece connector.

38. The packaging system of claim 34, wherein the shell of the coaxial connector further has a launch portion, the launch portion comprising a shelf extending axially from the feed thru portion, the integrated launch substrate being mounted on a shelf surface, the integrated launch substrate having circuitry defined on a surface of the launch substrate, the launch substrate circuitry providing an electrical transition from the coaxial connector to circuitry on a planar circuit mounted within the microcircuit package.
